(19) United States
(12) Patent Application Publication
(10) Pub. No.: US 2015/0347981 A1
(43) Pub. Date: Dec. 3, 2015

(54) CALENDAR APPLICATION FEATURES

(71) Applicant: Apple Inc., Cupertino, CA (US)

(72) Inventor: Scott Adler, Saratoga, CA (US)

(21) Appl. No.: 14/461,059

(22) Filed: Aug. 15, 2014

Related U.S. Application Data
(60) Provisional application No. 62/005,244, filed on May 30, 2014.

(51) Int. Cl. G06Q 10/10

(52) U.S. Cl. CPC G06Q 10/1095

(57) ABSTRACT

This application relates to a calendar application that can suggest alternative times and locations for events based on scheduling conflicts of invitees of the events. Suggestions for alternative times can include new times for the originally proposed event, and the names of any invitees that cannot attend during one or more of the alternative times. The calendar application can group the suggestions for alternative times based on the invitees that cannot attend at each alternative time. Additionally, the calendar application can determine whether the number of invitees will fit into a proposed location for the event, and suggest alternative locations based on the number of invitees.

### CROSS-REFERENCE TO RELATED APPLICATIONS

The present application claims the benefit under 35 U.S.C §119(e) to U.S. Provisional Application No. 62/005,244, entitled “CALENDAR APPLICATION FEATURES” filed May 30, 2014, the content of which is incorporated herein by reference in its entirety for all purposes.

### FIELD

The described embodiments relate generally to calendar applications. More particularly, the present embodiments relate to calendar applications capable of suggesting alternative event times based on the schedules of multiple invitees.

### BACKGROUND

Computing devices have been designed to assist people in a variety of ways since their availability on consumer markets. In particular, many computing device have been configured to provide a more efficient means to accomplish the everyday tasks of a consumer. Such tasks have included placing phone calls, buying various goods, reading books, and managing the time of the consumer. In order to manage time, many computing devices include calendar applications for keeping the appointments of the consumer. However, although many calendar applications can store the schedule of the person managing the calendar, often times the calendar applications do not interpret any other data available at the computing devices. In many cases, computing devices are able to connect to other devices over a network and gather information from the internet. Despite the available data and information, calendar applications are often not intuitive enough to use the information gathered from other sources to manage the calendar application more efficiently.

When planning appointments, calendar applications are often used to make appointments with other people. As one might expect, conflicts can arise when coordinating meetings and events with certain people. The people in which a particular event might be created for can have their own calendar filled with various events that make attending the event of someone else inconvenient. Although this information can be made available to others, the many calendar applications are not intelligent enough to resolve conflicts. Therefore, a user of a calendar application may not be able to make an appointment at any given time until the user has resolved a scheduling conflict with one or more persons. This can be a tedious process if the user is required to individually contact the potential invitees that the user wishes to make an appointment with. Moreover, even if the user is made aware of the upcoming events of those invitees, the user may not be able to accurately predict where the invitees will be at a given time during or between appointments. As a result, the user may be left guessing at locations that will be convenient for all invitees to meet. This guessing can cause inefficiencies when certain locations later prove to be unavailable for some of the invitees. In some instances, certain locations can be inconvenient for invitees not only because of their distance from the invitees but also because the location may not be appropriate due to a lack of accommodations at the location, such as limits on occupancy of a location. These limits can be detrimental to the happening of an event such as a meeting when a certain number of invitees are planning to attend but the location cannot accommodate the number of people. Although this information may be available in some way to the organizer of the event, the information may not be easily accessible at a time when the user is creating the event on a computing device.

### SUMMARY

This paper describes various embodiments that relate to systems, methods, and apparatus for creating calendar events based on the schedule of invitees for the calendar events. In some embodiments, a method for scheduling an event using a calendar application of a computing device is set forth. The method can include the steps of, at the calendar application, receiving time information for the event, receiving a list of invitees for the event, and receiving a location for the event. The method further includes a step of determining the availability of each of the invitees in the list of invitees. Additionally, when an invitee is unavailable at the time specified by the time information, the method includes causing an event suggestion to appear at a user interface of the computing device. The event suggestion includes an identifier for the invitee indicating that the invitee is unavailable and a suggested time that is different than the time information for the event.

In other embodiments, a machine-readable non-transitory storage medium is set forth. The storage medium can store instruction that, when executed by a processor included in a computing device, cause the computing device to carry out steps that include receiving a date and time for a proposed event, receiving a location for the proposed event, and receiving one or more names of invitees for the proposed event. The steps can further include determining an invitee schedule for each invitee associated with the one or more names of invitees. Additionally, the steps can include comparing the date and time for the proposed event with the invitee schedule. When the invitee schedule of an invitee indicates that the invitee is unavailable during the date and time for the proposed event, the steps can also include causing an event suggestion to be displayed at a user interface of the computing device. The event suggestion can include the name of the invitee that is unavailable.

In yet other embodiments, a machine-readable non-transitory storage medium is set forth. The storage medium can store instruction that, when executed by a processor included in a computing device, cause the computing device to carry out steps that include receiving a start time for a proposed event, receiving a location for the proposed event, and receiving a list of invitees for a proposed event. The steps can further include determining a schedule, before and after the start time, of each invitee on the list of invitees, and determining an occupancy limit for the location. When a total number of invitees from the list of invitees exceeds the occupancy limit, the steps can include causing a location suggestion icon to appear on a user interface of the computing device based on the occupancy limit. When a free period in the schedule of each invitee is such that each invitee is available during the free period, the steps can include causing a schedule suggestion icon to appear on a user interface of the computing device based on the free period.

Other aspects and advantages of the invention will become apparent from the following detailed description taken in conjunction with the accompanying drawings which illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a detailed view of a computing device displaying an interface of a calendar application.

FIG. 2 illustrates a system diagram of a computing device having a calendar application stored thereon.

FIG. 3 illustrates a method for creating an event using the calendar application according to some embodiments discussed herein.

FIG. 4 illustrates a method for creating an event using the calendar application according to some embodiments discussed herein.

FIG. 5 illustrates a method for creating an event using the calendar application according to some embodiments discussed herein.

FIGS. 6A-6B illustrate an interface of the calendar application according to some embodiments discussed herein.

FIG. 7 illustrates an embodiment of the calendar application that includes a search locations field for searching locations for the proposed event.

FIGS. 8A-8B illustrate variations of the conflict features of the calendar application according to some embodiments discussed herein.

FIGS. 9A-9B illustrate variations of the information entry portions of the calendar application according to some embodiments discussed herein.

FIG. 10 illustrates a variation of the time entry portion of the calendar application according to some embodiments discussed herein.

FIG. 11 illustrates a variation of the suggestions portion of the calendar application according to some embodiments discussed herein.

FIG. 12 illustrates a method for recommending a location for an event based on an occupancy limit of a room.

FIG. 13 illustrates a variation of the calendar application according to some embodiments discussed herein.

FIG. 14 illustrates a detailed view of a computing device that can be used to implement the various components described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

The embodiments set forth herein relate to a calendar application that allows a user to create events based on the schedule of the invitees of the events. The calendar application can perform conflict checking and thereafter notify the user of who is not available to attend the event. Additionally, the user can be presented with other suggested times for the event as well as the names of any invitees that cannot attend at the other suggested times. The suggestions can be grouped by times when all invitees can attend the event and times when one or more invitees cannot attend the event. The suggestions within these two groups can be arranged chronologically and include the names of the invitees who cannot attend at each respective time. The suggested times can be based on the originally proposed time for the event, and can include times both before the originally proposed time and after the originally proposed time. The suggestions can also be based on invitees that are indicated as required or optional. In this way, any suggested times where more required invitees can attend will be given priority when displaying suggestions to the user. Furthermore, any suggested times closest to the originally proposed time can also be given priority. The user can also remove invitees that may seem absolutely unavailable, thereby enabling the calendar application to provide more convenient suggestions that do not depend on any invitees who do not leave open space in their calendar. Suggestions for times can be based on the originally proposed time such that the suggested times can be approximately the same time but a different day than originally proposed. Moreover, the calendar application can infer a time based on the type of event. The type of event can be indicated by any information entered during the creation of the event that is suitable for inferring the type of event. The calendar application can receive a location for a proposed event in some embodiments and thereafter compare the total number of invitees to an occupancy limit of the location. If the total exceeds the occupancy limit, the calendar application can determine other locations to host the proposed event based on the total number of invitees and suggest other locations to the user. The total can be adjusted as invitees accept or reject the invitation to the event, and the calendar application can suggest alternative locations based on the adjusted total.

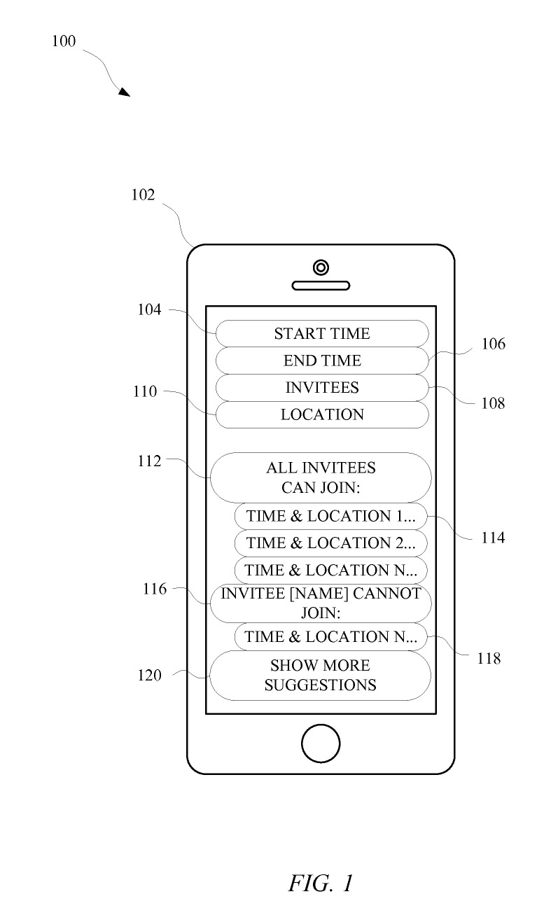

These and other embodiments are discussed below with reference to FIGS. 1-14; however, those skilled in the art will readily appreciate that the detailed description given herein with respect to these figures is for explanatory purposes only and should not be construed as limiting.

FIG. 1 illustrates a detailed view 100 of a computing device 102 displaying an interface of a calendar application. Specifically, FIG. 1 illustrates an embodiment of the calendar application where a user can supply data to a certain number of fields at the interface and receive data and location recommendations as a result. The interface of the calendar application includes a start time field 104 and an end time field 106. The start time field 104 and end time field 106 can be used to provide the calendar application with a start time and end time of a new or proposed event, respectively, that a user can create using the calendar application. The start time field 104 and end time field 106 can receive any suitable value or characters that are indicative of a start time and end time. For example, the start time field 104 and end time field 106 can receive value for calendar date, hours, minutes, seconds, time zone, as well as any other indicators of time. The interface of the calendar application can further include an invitees field 108. The invitees field 108 is configured to receive values for invitees or attendees that the user wishes to attend the event that the user is creating. The values for invitees can include names of invitees, email addresses, phone numbers, descriptions, or any suitable indicator that can define a person that is to be invited to an event. The values for invitees can be derived from a contacts application stored on the computing device 102 or a remote device such as a server. The number of values for invitees can be unlimited such that the user can provide any number of invitees to be invited to the event (e.g., 5 invitees, 100 invitees, etc.). The interface of the calendar application can also include a location field 110. The location field 110 is configured to receive values for a location of the event in which the user is creating. The values for location can include addresses, names, numbers, coordinates, or any suitable indicator that can define a location of an event. The values for location can be derived from a contacts application stored on the computing device 102, a remote device such as a server, or a navigation service coordinated in part by an application at the server.

During or after the entry of values into the interface of the calendar application, as discussed herein, the interface can display an invitees notification 112. The invitees notification 112 can provide notice or information regarding how many invitees can attend the proposed event according to the start time, end time, invitees, and/or location previously entered. In FIG. 1, a notice specifically stating that all invitees can join is illustrated, however, in some embodiments and instances the invitees notification 112 can set forth how many invitees can join the event and/or cannot join the event. Also included in the interface is a list or lists of event recommendations 114. The list of event recommendations 114 can include the exact event proposed according to the start time, end time, invitees, and location entered at the interface when all invitees can join the event according to the time and location parameters. This determination is made based on the calendar applications of the other invitees, or other schedule information obtained by the calendar application that indicates the availability of other invitees. Also included in the list of event recommendations 114 can be other recommendations for event times and locations relative to the time and location parameters entered at the interface, as further discussed herein. Based on schedule information of other invitees, the calendar application can look forward or backward in time relative to the original start time and end time parameters input into the calendar application and thereafter make recommendations for when at least some or all invitees and join the event. Additionally, the calendar application can make different location recommendations based on the schedule of other invitees, as further discussed herein. In some embodiments, the calendar application can include an invitees conflict notice 116. The invitees conflict notice 116 can advise who specifically cannot attend, and a modified list of event recommendations 118 can be displayed based on which invitees cannot attend. That is, the list of event recommendations 118 can include times and locations that all invitees can join the event except for the invitees listed on the invitees conflict notice. Any of the recommendations described herein can be activated by pressing on the screen, and, as a result, the recommendations can display further details regarding the time, location, and invitees that can join the respective recommendation (e.g., by pressing “TIME &LOCATION 1 . . . ,” the user can be shown more details regarding that recommendation). A more suggestions icon 120 is provided to allow the user to see even more recommendations with respect to time, location, and invitees, as further discussed herein. For example, after inputting values for start time, end time, location, and invitees, the user can be notified that a conflict of time exists for all invitees. If the user does not see adequate recommendations after first entering the event parameters, the user can click on the more suggestions icon 120 to be suggested even more event suggestions. The show more suggestions icon 120 can be modified to be more specific about the time of suggestions in some embodiments. For example, the show more suggestions icon 120 can ask if the user would like to look forward in time, look backward in time, and/or look for different locations that are more convenient to the user or invitees. These and other embodiments are discussed further herein.

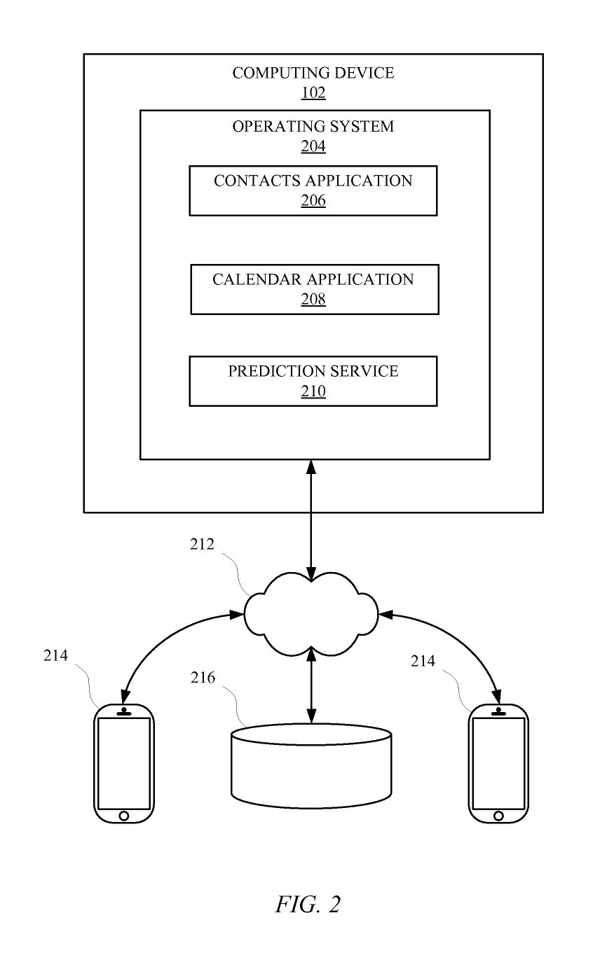

FIG. 2 illustrates a system diagram of a computing device 102 having a calendar application 208. Specifically, FIG. 2 illustrates how the calendar application 208 can discover scheduling conflicts when organizing an event with one or more persons. The computing device 102 can be any suitable type of computing device capable of creating a schedule for a user of the computing device 102. Such computing devices can include cell phones, laptops, tablet computers, desktop computers, and the like. The computing device 102 can include an operating system 204 that can include multiple applications and services. A contacts application 206 is included for providing a list of contacts for the user of the computing device 102. The contacts application 206 can include names, addresses, phone numbers, and any other suitable information related to a particular contact or person. A calendar application 208 is provided for managing the schedule of the user of the computing device 102. The calendar application 208 can receive various inputs from the user and make suggestions related to those inputs, as further discussed herein. A prediction service 210 is provided in order to assist the calendar application 208 in making suggestions for scheduling based on past behavior of the user of the computing device 102, as further discussed herein. The computing device 102 can communicate over a network 212 that can include other user computing devices 214 and a database 216 for storing the information of the other users and the user of the computing device 102. The database 216 can provide data related to the schedule and location of the user and any other users in order to provide better schedule and location suggestions when running the calendar application 208. This data can also be provided from the other user computing devices 214. The data can be transmitted over the network 212 or directly between the computing device 102 and the other user computing devices 214.

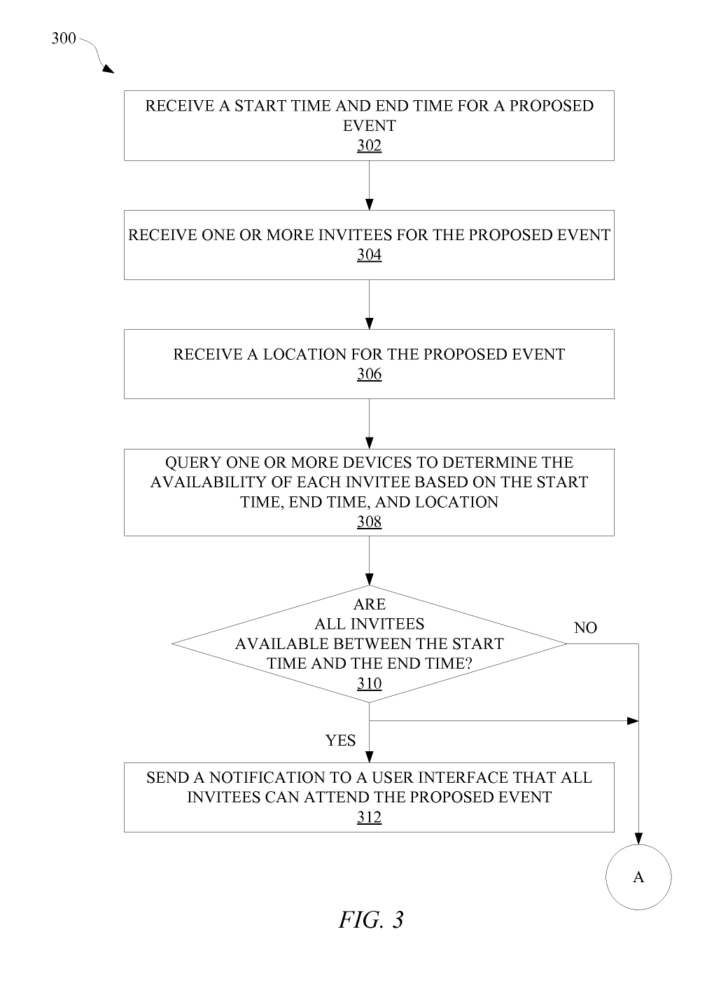

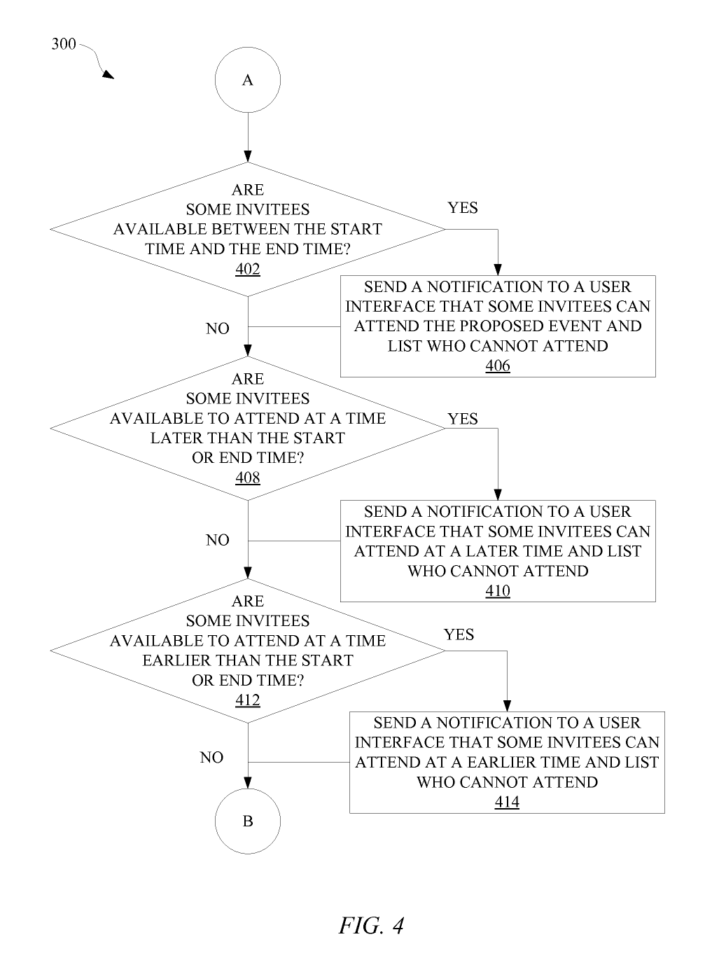

FIG. 3 illustrates a method 300 for creating an event using the calendar application 208. Specifically, method 300 describes organizing an event based on the availability of other invitees of the event, as further described herein. At step 302 of method 300, the calendar application 208 receives a start time and an end time for a proposed event. At step 304, the calendar application 208 receives one or more invitees, or values indicative of invitees, for the proposed event. Further, at step 306, the method 300 includes receiving a location for the proposed event. At step 308, the calendar application 208 can query one or more devices to determine the availability of each invitee based on the start time, end time, and location. The one or more devices can be a mobile phone, server, desktop computer, tablet computer, or any device that can provide availability information related to the schedule and location of an invitee of a proposed event. At step 310, the calendar application 208 can determine whether all invitees are available between the start time and the end time. This determination is based on the availability information gathered at step 308. If not all of the invitees are available between the start time and the end time, the calendar application 208 proceeds to node A, which acts as a transition to node A in FIG. 4. Otherwise, if all of the invitees can attend between the start time and the end time, a notification is sent to a user interface of the computing device 102 indicating that all invitees can attend the proposed event and the calendar application 208 proceeds to node A for further processing.

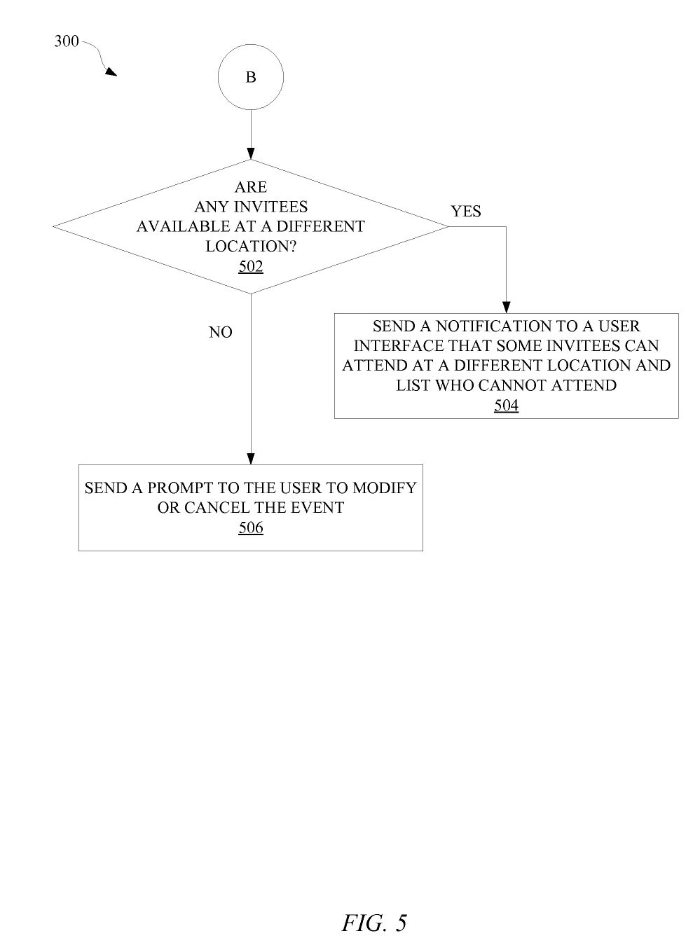

FIG. 4 illustrates a method 300 for creating an event using the calendar application 208. Specifically, FIG. 4 is a continuation of method 300 from FIG. 3 at node A. At step 402, after node A, the calendar application 208 determines whether some invitees are available between the start time and the end time. If some invitees are available between the start time and the end time, then at step 406 the calendar application sends a notification to a user interface that indicates some invitees can attend the proposed event. The notification can also include a list of any invitees who cannot attend the proposed event. The method 300 can then proceed to step 408 for further processing. If no invitees are available between the start time and the end time, the method 300 can proceed to step 408 where the calendar application 208 can determine whether some invitees are available to attend at a time later than the start time or the end time. If some invitees can attend at a later time than the start time or the end time, the calendar application 208 proceeds to step 410. At step 410, a notification is sent to a user interface indicating that some invitees can attend at a later time, and a list of those invitees who cannot attend can be included in the notification. The calendar application 208 can then proceed to step 412 where the calendar application 208 determines whether some invitees can attend at a time earlier than the start time or the end time. If the some invitees can attend at a time earlier than the start time or the end time, the calendar application 208 proceeds to step 414. At step 414, a notification is sent to the user interface indicating that some invitees can attend at an earlier time, and a notification can include a list of invitees who cannot attend at the earlier time. The calendar application 208 can then proceed to node B, which acts as a transition to node B at FIG. 5. At step 412, if some invitees are not available to attend at a time earlier than the start time or the end time, the calendar application proceeds to node B at FIG. 5.

FIG. 5 illustrates a method 300 for creating an event using the calendar application 208. Specifically, FIG. 5 is continuation of method 300 from FIGS. 3 and 4, starting at node B. At step 502 after node B, the calendar application 208 determines whether any invitees are available at a difference location. If any invitees are available at a different location, the calendar application 208 proceeds to step 504 where the calendar application 208 sends a notification to a user interface that some, or all, invitees can attend at a different location than the originally proposed location. The notification of step 504 can include a list of who cannot attend at the different location. At step 506, if none of the invitees are available at a different location, the calendar application 208 can send a prompt to the user to modify or cancel the event. If the user chooses to modify the event then the calendar application 208 can start the method 300 over again, otherwise the calendar application 208 can terminate method 300.

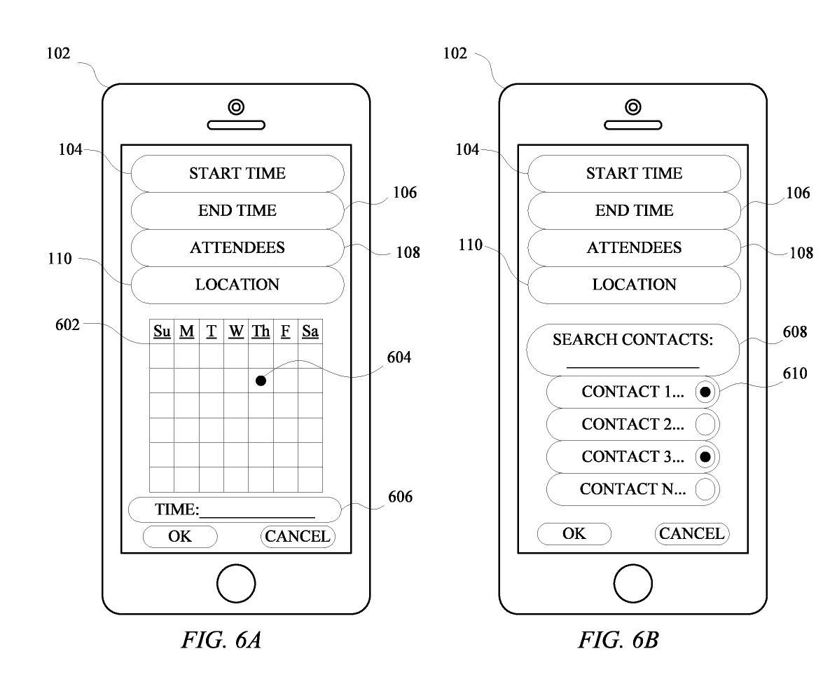

FIGS. 6A-6B illustrate an interface of the calendar application 208 according to some embodiments discussed herein. Specifically, FIGS. 6A-6B are set forth as examples of the user interface for creating events with the calendar application 208. As discussed herein, the computing device 102 can display one or more user interfaces controlled in part by the calendar application 208. An embodiment of the calendar application 208 of FIG. 6A can include a start time field 104, and end time field 106, an invitees field 108, and a location field 110. When a user is supplying a start time and end time into the calendar application 208, the calendar application can provide a calendar interface 602 for indicating the date or range of dates of the proposed event. The selected date 604 can be highlighted or otherwise indicated as selected when a user presses on the desired date for the event. The calendar application 208 can also provide a time field 606 for typing in a date and time for the proposed event. When the user selects the time field 606, a keyboard can appear on the display of the computing device 102 for a user to input data into the computing device 102, including any data for operating the calendar application 208 (e.g., data for the time field 606).

FIG. 6B illustrates an embodiment of the calendar application 208 that includes a search contacts field 608 for searching a list of contacts stored at the computing device 102 or a remote device connected to the computing device 102. The list of contacts can be managed by the contacts application 206, as discussed herein. When using the search contacts field 608, a keyboard can appear on the display of the computing device 102 in order to receive data for searching the list of contacts. After a user has input data into the search contacts field 608, a user can select a contact 610 in order to include the contact 610 as an invitee of the proposed event. A selected contact can be indicated by a filled in circle, and the user can press “OK” or “CANCEL” in order to accept or decline the selected contacts as invitees. In some embodiments, and as further discussed herein, the user can select whether the contact is a required contact or an optional contact, and the calendar application 208 can suggest times and locations for events according to whether required and/or optional contacts can attend.

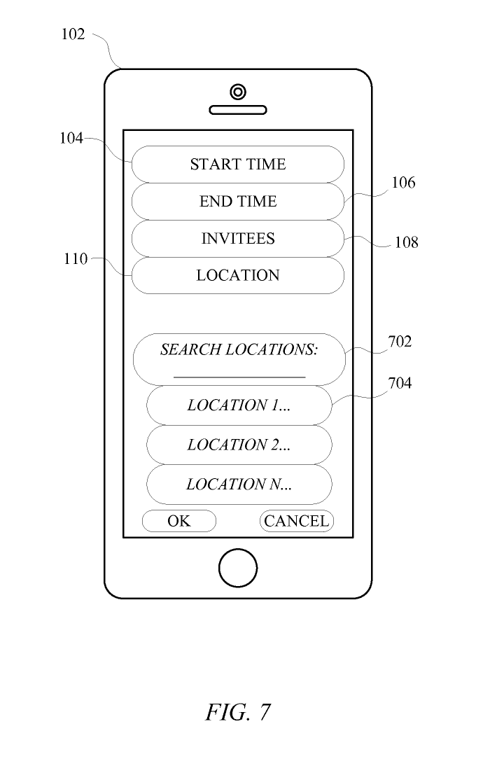

FIG. 7 illustrates an embodiment of the calendar application 208 that includes a search locations field 702 for searching locations for the proposed event. As discussed herein, the calendar application 208 can include a start time field 104, and end time field 106, an invitees field 108, and a location field 110. The location field 110 can be filled in according to the selected search results from the search locations field 702. The locations that can include any locations stored on the computing device 102, and any locations or addresses available to the computing device 102 over the network 212. The network 212 can include the internet and can therefore provide any location data accessible over the internet. The network 212 can also be connected to a database 216 and/or other user computing devices 214, which provide location information of potential invitees that can be included on the proposed event. Once the user has provided some amount of data into the search locations field 702, one or more locations 704 can be listed for the user to choose from. The user can then select a location 704 by pressing on the location 704 listed at the display of the computing device 102 and cause the location field 110 to be filled in with the selected location 704.

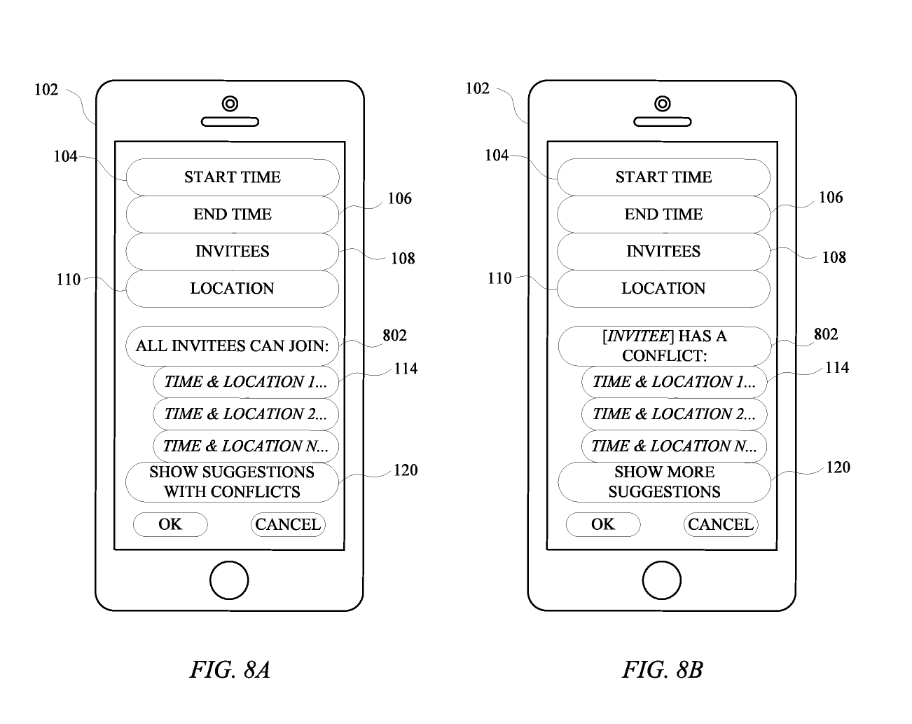

FIGS. 8A-8B illustrate variations of the calendar application 208 according to some embodiments discussed herein. Specifically, FIGS. 8A-8B are set forth as examples of the user interface for displaying the results of inputting the time, location, and invitees, events with the calendar application 208. The calendar application 208 of FIG. 8A includes a start time field 104, and end time field 106, an invitees field 108, and a location field 110. The user interface for the calendar application 208 can also include an invitee status 802. The invitee status 802 can include a list of invitees who can attend or cannot attend according to the schedule and location information obtained from a device associated with the invitee. As shown in FIG. 8A, if all invitees can join the event, the calendar application 208 will list the date, time, and location in a list of event recommendations 114. The event recommendations can correspond to the invitee status 802, and therefore when all invitees can attend the proposed event, the list of event recommendations 114 will correspond to times and locations for the event as exactly proposed, or near the time and location of the proposed event. If the calendar application 208 determines that some invitees cannot join the proposed event but some invitees can join, the calendar application 208 can cause a suggestions icon 120 to appear. When the user presses the suggestions icon 120, the calendar application 208 can cause the user interface to display more suggestions that include times and locations of events that only some invitees can join, as illustrated in FIG. 8B. In FIG. 8B, the invitee status 802 will list any invitees that cannot join the events listed in the list of event recommendations 114. In this way, the user will be able to quickly tell who cannot join the event if the event is planned according to one or more of the suggested events (e.g., “TIME & LOCATION 1 . . . . ” or “TIME & LOCATION 2 . . . . ”). In some embodiments, the invitee or invitees who are predicted to not be able to attend can be listed next to or proximate to each of the suggested events of the list of event recommendations 114. Additionally, if the user would like to see even more suggested events, the user can again press the suggestions icon 120 in order to view another list of event recommendations.

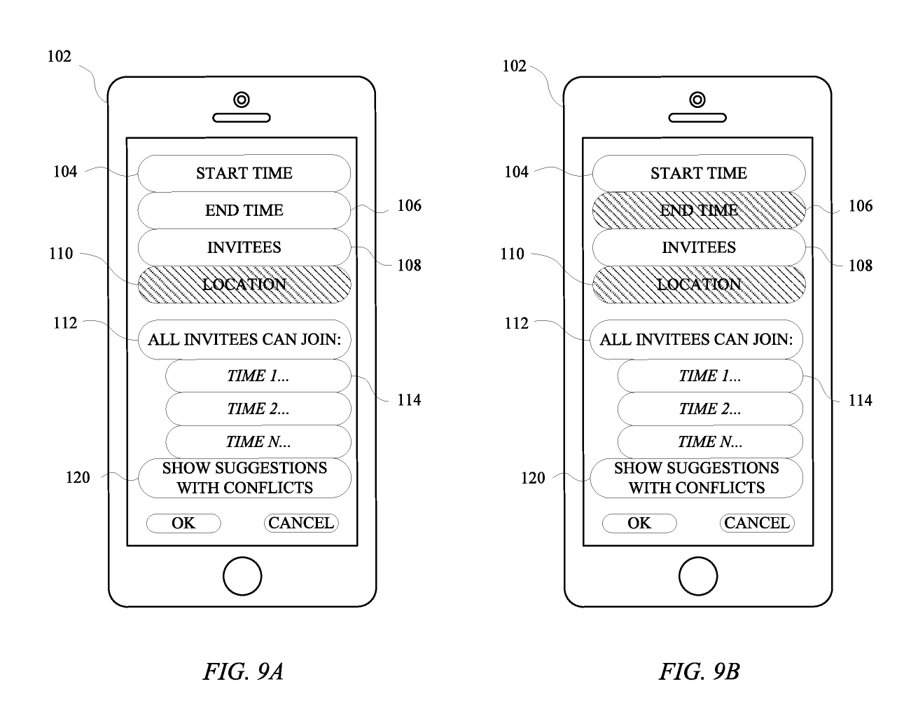

FIGS. 9A-9B illustrate variations of the calendar application 208 according to some embodiments discussed herein. Specifically, FIG. 9A illustrates an embodiment of the calendar application 208 where an event can be proposed using data entered at the start time field 104, the end time field 106, and the invitees field 108. In this way, suggestions can be made for the event as discussed herein without requiring data to be entered at the location field 110. FIG. 9B illustrates an embodiment of the calendar application 208 wherein an event can be proposed using data entered at the start time field 104 and the invitees field 108. Suggestions can then be made by the calendar application 208 without requiring data to be entered at the end time field 105 and the location field 110. This is beneficial to the user because the user may frequently make events at the same location, therefore by removing the step of adding a location the user can more efficiently create events with the calendar application 208.

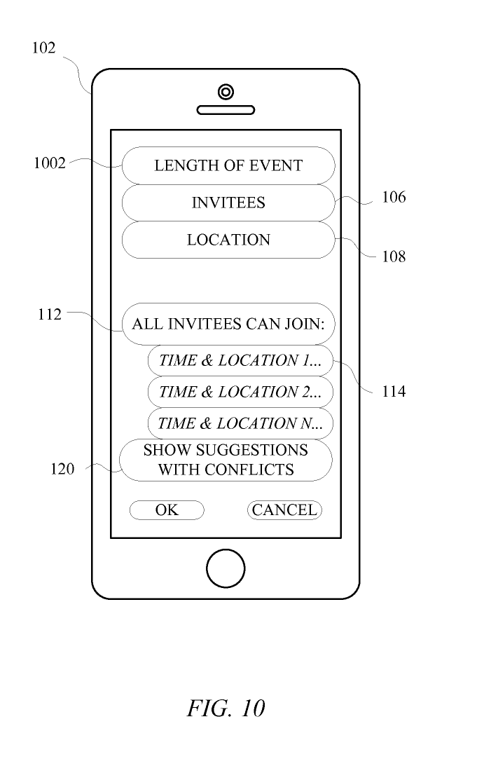

FIG. 10 illustrates a variation of the calendar application 208 according to some embodiments discussed herein. Specifically, FIG. 10 illustrates an embodiment of the calendar application 208 where a length of event field 1004 is provided in order to enter the length of a particular proposed event. In this way, suggestions for events can be based on data entered into the length of event field 1004, the invitees field 108, and the location field 110, without using a start and end time for an event. The embodiment of FIG. 10, as well as any other embodiment discussed herein can use data from the prediction service 210 in order to predict the data that is to be entered into the various fields of the calendar application 208. For example, when the user is entering the start time, end time, or length of event into the calendar application 208, the prediction service 210 can be queried to determine who the user typically invites to events that are scheduled using the calendar application 208. The determination can be made based on the start time, end time, and/or length of event and thereafter provide a list of predicted invitees for the user to select from. The predicted list of invitees can also be based on the data entered into the location field 110. Additionally, if the user chooses to input one or more invitees first into the invitees field 108, the start time, end time, length of event, and/or location data can be determined based on the prediction service 210. For example, if the user is scheduling an event with a co-worker, the location can be a meeting room at the office of the co-worker if the prediction service 210 determines that this is the most probable location the user is going to choose based on a history of events that have been created by the calendar application 208. Any suitable data can be inferred from the prediction service 210 upon the prediction service 210 gathering historical data regarding the previous events of the user and determining trends and variations of the historical data.

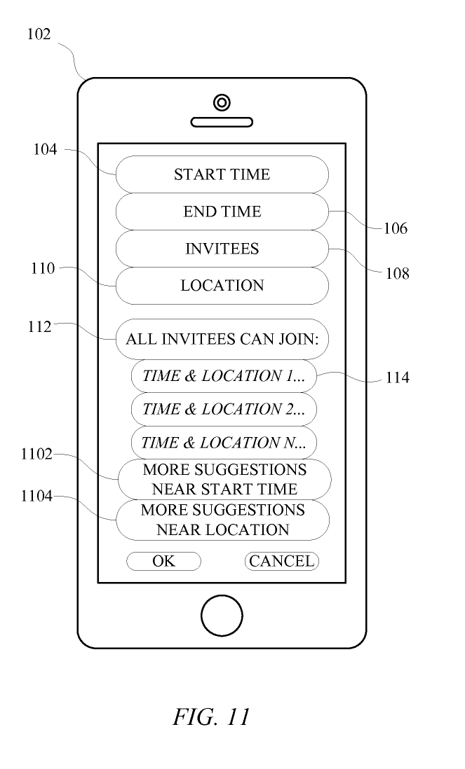

FIG. 11 illustrates a variation of the calendar application 208 according to some embodiments discussed herein. Specifically, FIG. 11 illustrates an embodiment of the calendar application 208 where a near time suggestion icon 1102 and near location suggestion icon 1104 are incorporated. The near time suggestion icon 1102 operates to provide the user with more suggestions for event times and locations based on the start time, end time, or length of event provided to the calendar application 208. For example, if the user is scheduling meeting at noon in a week, when the user presses the near time suggestion icon 1102 the user can be provided with additional suggestions that are earlier or later than noon from the day originally proposed. This amount of time earlier or later to the originally time proposed can depend on the type of meeting, the length of the proposed meeting, the invitees, the location, and/or any suitable information obtained from the prediction service 210, database 216, or other user computing devices 214. The near location suggestion icon 1104 operates to provide the user with more suggestions for event locations based on the originally proposed location of the event provided to the calendar application 208. For example, if the user is scheduling a dinner event, the user can press the near location suggestion icon 1104 and be provided with additional suggestions for the location of the event that are near the originally proposed location for the event. The additional suggestions for locations can be based on the type of event, the time and length of the proposed event, the invitees, the originally proposed location, and/or any suitable information obtained from the prediction service 210, database 216, or other user computing devices 214. For example, an additional suggestion for location and/or start time can be based on the schedule of an invitee, and the schedule of the invitee can be stored on the other user computing devices 214 that can be associated with the invitee. Moreover, additional suggestions for location can be derived from the space available or occupancy limits of a location, as discussed herein.

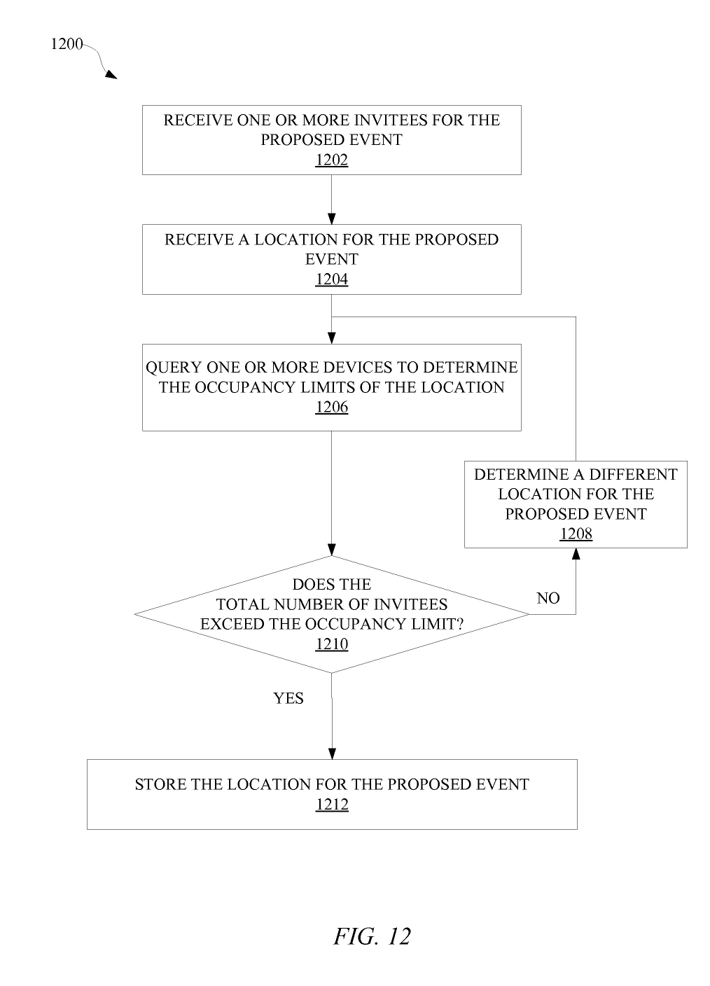

FIG. 12 illustrates a method 1200 for recommending a location for an event based on an occupancy limit of a room. Specifically, FIG. 12 illustrates a method 1200 of using the calendar application 208 to recommend a location for an event based on one or more space limitations of a particular location. At step 1202, the calendar application 208 can receive one or more invitees for the proposed event. At step 1204, the calendar application 208 can receive a location for the proposed event. Using the location, the calendar application, at step 1206, can query one or more devices to determine the occupancy limits of the location. For example, when the location is a room of an office building, the calendar application 208 can query a network database of the office building to determine the occupancy limit of the room, the dimensions of the room, the number of tables or chairs in the room, and/or any other information indicative of an occupancy limit. Based on the occupancy limit, the calendar application 208 can determine at step 1210 whether the total number of invitees exceeds the occupancy limit of the location. If the total number of invitees exceeds the occupancy limit of the location, the calendar application 208 can, at step 1208, determine a different location for the proposed event. The calendar application 208 can determine the different location by querying the prediction service 210 to determine what past locations have been used. The calendar application 208 can also query an internal storage or external network to determine other suitable locations that are comparable to the originally proposed location, but have a better occupancy limit for holding the proposed event. Once a different location is determined, the calendar application 208 can proceed to step 1206. However, if the total number of invitees does not exceed, or is equal to, the occupancy limit of the location, the calendar application 208 can store the location for the proposed event. In this way, the user does not have to worry about whether the event location will fit the number of invitees that are being invited. In some embodiments, the user can receive a notification when invitees accept and decline the invitations that the invitees receive. If the originally proposed room was too small for the total number of invitees, and the event is scheduled to be in a larger room, the originally proposed room can be suggested again. In this way, if the total number of invitees falls within the occupancy limit of the originally proposed room after one or more invitees decline the invitation, the location that the user originally desired for the event can be retrieved and used as the location for the event. This embodiment can also be used when the user adds invitees after the calendar application 208 has already determined that the location was adequate, based on occupancy limits and the total number of invitees prior to the user adding more invitees. Once the user adds invitees thereafter, a larger location can be suggested.

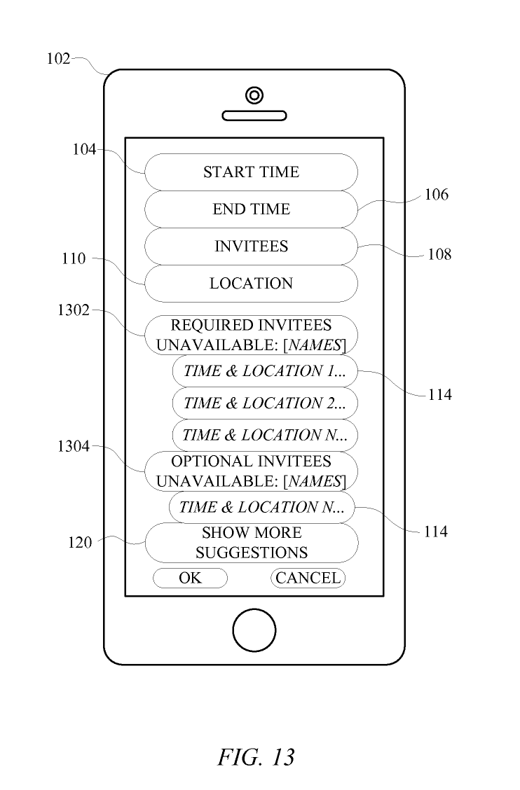

FIG. 13 illustrates a variation of the calendar application 208 according to some embodiments discussed herein. Specifically, FIG. 13 sets forth an embodiment of the calendar application 208 where suggestions displayed for event times and locations are based on the number of required invitees that are available during the suggested event times. When a user inputs data into the various fields of the calendar application 208, as discussed herein, the user can be prompted to input a list of contacts into the invitees field 108. The user can indicate the contacts to be included in the proposed event and also choose the contacts that are required or optional. Thereafter, when the calendar application 208 is determining whether the invitees can join the event based on the schedules of the invitees, the calendar application 208 can display suggestions for times and locations of the proposed event based on how many required and optional invitees can or cannot join each of the suggestions. Any required invitees that cannot join one or more of the suggested event times and locations can be indicated on a required invitees icon 1302. Similarly, any optional invitees that cannot join one or more of the suggested event times and locations can be indicated on an optional invitees icon 1304. The times and locations suggestions listed in each of the list of event recommendations 114 can correspond to the required invitees icon 1302 and the optional invitees icon 1304 respectively. For example, the list of event recommendations 114 directly below the required invitees icon 1302 can correspond to times and locations when one of the required invitees cannot join; and the list of event recommendations 114 directly below the optional invitees icon 1304 can correspond to a time and location when one of the optional invitees cannot join. As shown in FIG. 13, it is possible for the same time and location to be shown in both lists of event recommendations 114 indicating that one or more required and optional invitees cannot join the event at that specific time and location. Moreover, by providing the names of the required and optional invitees that cannot join each of the suggested times and locations, a user can select or refine the event according to the schedule of the invitees the user finds most relevant to the event.

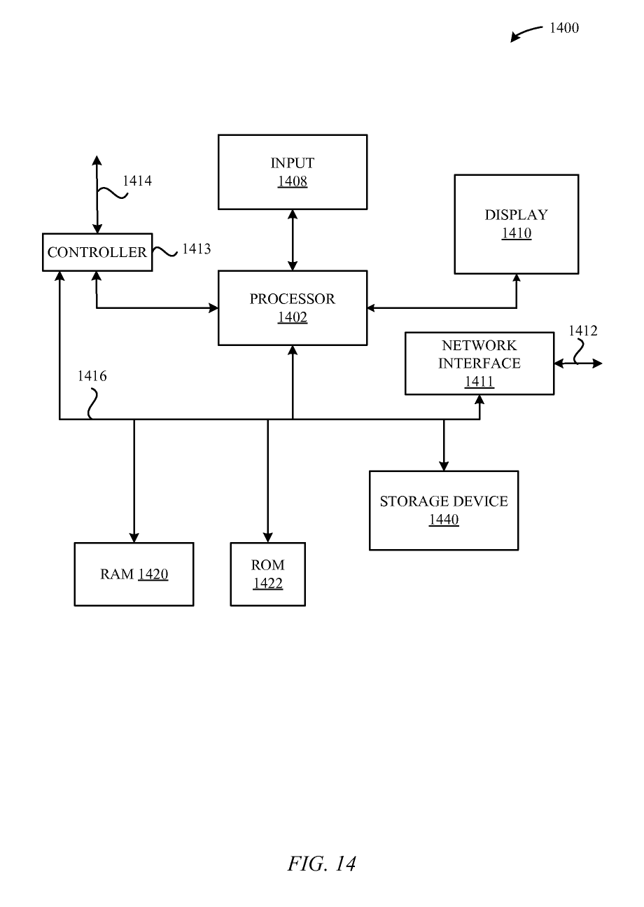

FIG. 14 illustrates a detailed view of a computing device 1400 that can be used to implement the various components described herein, according to some embodiments. In particular, the detailed view illustrates various components that can be included in the computing device 102 illustrated in FIG. 1. As shown in FIG. 14, the computing device 1400 can include a processor 1402 that represents a microprocessor or controller for controlling the overall operation of computing device 1400. The computing device 1400 can also include a user input device 1408 that allows a user of the computing device 1400 to interact with the computing device 1400. For example, the user input device 1408 can take a variety of forms, such as a button, keypad, dial, touch screen, audio input interface, visual/image capture input interface, input in the form of sensor data, etc. Still further, the computing device 1400 can include a display 1410 (screen display or user interface) that can be controlled by the processor 1402 to display information to the user. A data bus 1416 can facilitate data transfer between at least a storage device 1440, the processor 1402, and a controller 1413. The controller 1413 can be used to interface with and control different equipment through and equipment control bus 1414. The computing device 1400 can also include a network/bus interface 1411 that couples to a data link 1412. In the case of a wireless connection, the network/bus interface 1411 can include a wireless transceiver. For example, for computing device 1400, the network/bus interface 1411 can include radio transceiver to connect with a plurality of communication networks associated with a plurality of mobile network operators.

The computing device 1400 also include a storage device 1440, which can comprise a single disk or a plurality of disks (e.g., hard drives), and includes a storage management module that manages one or more partitions within the storage device 1240. In some embodiments, storage device 1440 can include flash memory, semiconductor (solid state) memory or the like. The computing device 1400 can also include a Random Access Memory (RAM) 1420 and a Read-Only Memory (ROM) 1422. The ROM 1422 can store programs, utilities or processes to be executed in a non-volatile manner. The RAM 1420 can provide volatile data storage, and stores instructions related to the operation of the computing device 1400.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, HDDs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A machine-readable non-transitory storage medium storing instructions that, when executed by a processor included in a computing device, cause the computing device to carry out steps that include:
receiving a start time for a proposed event;
receiving a location for the proposed event;
receiving a list of invitees for the proposed event;
determining a schedule of each invitee on the list of invitees;
determining an occupancy limit for the location;
when a total number of invitees from the list of invitees exceeds the occupancy limit, causing an alternate location suggestion icon to appear on a user interface of the computing device based on the occupancy limit; and
when a free period in the schedule of each invitee is such that each invitee is available during the free period, causing a schedule suggestion icon to appear on the user interface of the computing device for providing additional event times in accordance with the free period.

2. The machine-readable non-transitory storage medium of claim 1, further including a step of, when a conflict period in the schedule of a conflicting invitee is such that the conflicting invitee is unavailable during the free period, causing a conflict suggestion icon and a name of the conflicting invitee to appear on the user interface.

3. The machine-readable non-transitory storage medium of claim 1, wherein the alternate location suggestion icon, when activated, causes a search for a new location to be performed based on the total number of invitees.

4. The machine-readable non-transitory storage medium of claim 1, further including a step of, when the schedule suggestion icon is activated, displaying a list of new start times that are different than the start time for the proposed event.

5. The machine-readable non-transitory storage medium of claim 1, wherein determining the schedule of each invitee includes searching ahead of the start time to a forward search limit or searching before the start time to a backward search limit.

6. The machine-readable non-transitory storage medium of claim 1, further including a step of, when multiple invitees are unavailable during the start time, displaying a list of the multiple invitees and a list of suggested times at the user interface, wherein the suggested times are different than the start time and correspond to periods when the each invitee of the multiple invitees are concurrently unavailable.

7. The machine-readable non-transitory storage medium of claim 1, further including a step of, when each invitee is available at a first suggested time:
causing the user interface to display the first suggested time; and
determining a second suggested time when at least one invitee is not available, and a name of the at least one invitee that is not available.

8. A method for scheduling an event using a calendar application of a computing device, the method comprising:
at the calendar application:
receiving a first time for the event;
receiving a list of invitees for the event;
receiving a location for the event;
determining an availability of each of the invitees in the list of invitees; and
when a first invitee is unavailable at a first time and a second time, wherein the first time is different than the second time, and a second invitee is available during the second time:
causing an event suggestion to appear at a user interface of the computing device, wherein the event suggestion includes: the second time and an identifier for the first invitee indicating that the invitee is unavailable during the second time.

9. The method of claim 8, wherein determining the availability of each of the invitees comprises:
searching a schedule of each invitee in the list of the invitees both forward in time and backward in time relative to the first time; and
storing an available time for each of the invitees.

10. The method of claim 8, further comprising:
determining an occupancy limit for the location; and
determining whether a total number of invitees exceeds the occupancy limit.

11. The method of claim 8, wherein, when multiple invitees are unavailable at the first time:
causing multiple time suggestions to appear at the user interface of the computing device, wherein each time suggestion of the multiple times suggestions corresponds to a different suggested time than the first time for the event.

12. The method of claim 8, wherein, when all invitees are available during the first time:
causing a conflicts icon to appear at the user interface, wherein the event suggestion is displayed as a result of the user activating the conflicts icon.

13. The method of claim 8, further comprising:
determining an occupancy limit for the location; and
when a total number of invitees exceeds the occupancy limit:
querying a location database, and
determining a location suggestion for an alternative location that has an alternative occupancy limit equal to or greater than the total number of invitees.

14. The method of claim 8, wherein the event suggestion is based on the availability of multiple invitees and the first time for the event.

15. A device, comprising:
a processor; and
a memory storing instructions that, when executed by the processor, cause the processor to carry out steps that include:
receiving a date and time for a proposed event;
receiving a location for the proposed event;
receiving one or more names of invitees for the proposed event;
determining an invitee schedule for each invitee associated with the one or more names of invitees;
determining a suggested date and a suggested time for the proposed event;
comparing the date and time for the proposed event with the invitee schedule; and
when the invitee schedule of an invitee indicates that the invitee is unavailable during the date and time for the proposed event and the suggested date and the suggested time for the proposed event, causing an event suggestion to be displayed at a user interface of the device, wherein the event suggestions includes the name of the invitee that is unavailable and the suggested date and the suggested time.

16. The device of claim 15, wherein the steps further include, when multiple invitee schedules indicate that multiple invitees are unavailable during the date and time for the proposed event, causing a list of multiple event suggestions to be displayed at the user interface, wherein the list of multiple event suggestions includes at least two different proposed dates and times for the proposed event, and a name of a conflicting invitee that is unavailable during the at least two different proposed dates and times for the proposed event.

17. The device of claim 15, wherein the steps further include receiving an assignment for each of the names of invitees indicating that the invitee is required or optional with respect to attending the proposed event.

18. The device of claim 17, wherein the steps further include, when the invitee schedule of an invitee indicates that a required invitee and an optional invitee are unavailable during the date and time for the proposed event, causing multiple event suggestions to be displayed at the user interface, wherein at least a first event suggestion of the multiple event suggestions includes a name of the required invitee and a second event suggestion of the multiple event suggestions includes a name of the optional invitee.

19. The device of claim 15, wherein the steps further include, when multiple invitee schedules of the invitees indicate that all of the invitees are available during the date and time for the proposed event, causing a suggestions icon to appear, wherein the suggestions icon, when activated, causes a determination to be made of whether other dates and times exist when one or more of the invitees are available.

20. The device of claim 15, wherein the steps further include, when multiple invitee schedules of the invitees indicate that all of the invitees are available during the date and time for the proposed event, causing a suggestions icon to appear at the user interface of the device, wherein the suggestions icon, when activated, causes a determination to be made of an additional time one or more invitees are unavailable.
